(19) United States
(12) Patent Application Publication
(10) Pub. No.: US 2009/0097653 A1
(43) Pub. Date: Apr. 16, 2009

(54) ENCRYPTION KEY STORED AND CARRIED BY A TAPE CARTRIDGE

(76) Inventor: Ole Christian Dahlerud, Oslo (NO)

Correspondence Address: SCHIFF HARDIN, LLP;PATENT DEPARTMENT, 6600 SEARS TOWER, CHICAGO, IL, 60606-6473, US

(21) Appl. No.: 11/870,485

(22) Filed: Oct. 11, 2007

(51) Int. Cl. H04L 9/00

(52) U.S. Cl. 380/277

(57) ABSTRACT

In a cartridge key carrier, a data processing system employing an encryption key carrier, and a method for communicating an encryption key, an empty cartridge housing is provided that has a standardized form factor allowing insertion of the cartridge into a standardized magnetic tape drive. A memory chip is permanently attached to the cartridge housing, and has an encryption key stored therein. The memory chip has a chip configuration that allows readout of the encryption key from the memory chip when the housing is inserted into the tape drive.

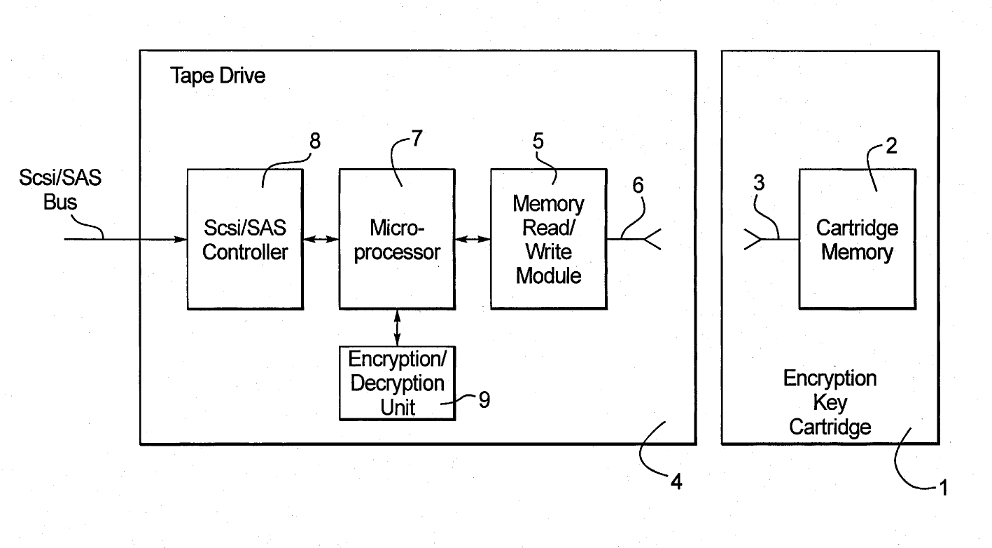

### BACKGROUND OF THE INVENTION

1. Field of the Invention

The present invention relates to a carrier for an encryption key that is necessary to encrypt or decrypt data carried by a data carrier and transferred between the data carrier and a data processor.

2. Description of the Prior Art

The use of encryption keys for encrypting and decrypting data is well known. A constant problem associated with the use of encryption algorithms requiring an encryption key is the necessity of restricting access to the encryption key only to authorized persons. Because of the necessity of keeping the key secret from unauthorized users, transferring the key via a data bus is not an acceptable solution.

In the context of data that are stored on a magnetic tape that is spooled in a cartridge housing, it is known to provide a memory chip that is physically attached to the housing, and to store information in the chip associated with the data that are carried by the tape in the cartridge. The information can be read from the chip, for example, by a tape drive in which the cartridge is inserted.

This information can include identifiers as to the source of the data or the date on which the data were recorded, and can also include special instructions for reading and/or writing data relative to the tape. It is also known to store an encryption key for the data on the tape that is spooled in the same cartridge to which the memory chip is attached.

Although storing an encryption key in such a memory chip avoids the necessity of informing the tape drive, or the owner of the tape drive, of the contents of the encryption key by means of a data bus or some other unsecured communication link, this approach has the disadvantage of permanently physically combining the encryption key with the tape that is spooled in the cartridge. If large amounts of data are to be encrypted or decrypted using the same key, and if this amount exceeds the amount of data that can be carried by the tape that is spooled in the cartridge, this means that multiple cartridges, with the same encryption key stored therein, must be provided, with portions of the total amount of data being stored on the tape in each cartridge. The more locations that the encryption key is present, the more likely it is that the key will be accessible by an unauthorized party, and therefore the security of the key is compromised.

Moreover, these types of cartridges have a certain inflexibility associated therewith, since the memory chip containing the key, and the data carried by the tape spooled in the cartridge, must always be used together. Moreover, if the encryption key becomes out of date or discovered by unauthorized persons, the security of the data stored in that cartridge is immediately compromised, but unless the precise location of the cartridge has been tracked and is known, it may be difficult to retrieve the cartridge in a timely manner.

### SUMMARY OF THE INVENTION

It is an object of the present invention to provide away to communicate an encryption key for data that will be, or are, stored in a tape medium in a cartridge, that avoids the problems of conventional approaches discussed above.

The object is achieved in accordance with the present invention by a cartridge key carrier, a data processing system employing an encryption key carrier, and a method for communicating an encryption key, wherein an empty cartridge housing is provided that has a standardized form factor allowing insertion of the cartridge into a standardized magnetic tape drive. A memory chip is permanently attached to the cartridge housing, and has an encryption key stored therein. The memory chip has a chip configuration that allows readout of the encryption key from the memory chip when the housing is inserted into the tape drive.

The term “empty” cartridge as used herein means a cartridge that, although having a shape and configuration conforming to a standardized form factor for a particular type of tape medium, does not actually contain any tape, i.e., it does not have tape spooled therein. The empty cartridge can then be inserted into the tape drive that will be used to read data from, or write data onto, tape that is spooled in subsequently-inserted cartridges according to an encryption/decryption algorithm making use of the stored key. Once the empty cartridge has been inserted into the tape drive and encryption key has been read from the memory chip attached to that empty cartridge, any number of subsequently-inserted, tape-containing cartridges can be inserted into, and removed from, the tape drive, with encrypted date being read from those cartridges, or encrypted data being written onto the tape spooled in those cartridges, using the encryption key that has now been transferred into, and stored in, the tape drive.

In accordance with the invention, therefore, one and only one empty tape cartridge is used as a key-conveying article or carrier. The encryption key, although being used with other cartridges having the same form factor that do contain tape, is usable completely independently of those other cartridges. Any amount of data thus can be read or written using a single encryption key, without restriction as to the data capacity limit that is imposed by the particular form factor. Moreover, if the key itself should become known or out of date, or even if the empty cartridge carrying the memory chip in which the encryption key is stored comes into the possession of an unauthorized user, the data that have been encrypted by the key are still not necessarily accessible to the unauthorized user, since the encrypted data are stored in cartridges that are physically separate from the empty cartridge.

### BRIEF DESCRIPTION OF THE DRAWING

The single FIGURE is a block diagram of an encryption key carrier constructed and operating in accordance with the present invention, suitable for use in a method and system in accordance with the present invention.

### DESCRIPTION OF THE PREFERRED EMBODIMENTS

As shown in the FIGURE, an encryption key cartridge 1 contains a cartridge memory 2. Other than the cartridge memory 2, the encryption key cartridge is empty. More specifically, the encryption key cartridge does have any tape spooled therein.

The encryption key cartridge has a cartridge form factor that is standardized for a particular type of tape medium or tape drive, and is insertable into a tape drive 4 that has a corresponding form factor. Many such form factors are known and commercially available, such as the LTO form factor. The tape drive 4 includes a memory read/write module 5 that is able to read the encryption key from the cartridge memory 2, after the encryption key cartridge 1 has been inserted into the tape drive 4.

In the exemplary embodiment shown in the FIGURE, such reading or writing ensues wirelessly, as indicated by an antenna 3 in communication with the cartridge memory 2, and an antenna 6 in communication with the memory read/write module 5. The antennas 3 and 6 communicate each other with a communication link that exists only when the encryption key cartridge 1 is properly inserted in the tape drive 4.

As an alternative to the exemplary embodiment shown in the FIGURE, which is preferred, the cartridge memory 2 may come into direct contact with the memory read/write module 5 when the encryption key cartridge is inserted into the tape drive 4, such as by a direct, but temporary, electrical connection.

The wireless or direct connection also provides the necessary power to the cartridge memory 2 in order to enable the transfer of the encryption key.

When a cartridge having the same form factor as the encryption key cartridge, but having magnetic tape spooled therein, is subsequently inserted into the tape drive, the encryption key, now stored in the tape drive, can be used for the transfer of data between the tape drive 4 and the tape spooled in the subsequently-inserted cartridge. If the subsequently-inserted cartridge already contains data that have been encrypted according to the stored encryption key, the encryption key is used by an encryption/decryption unit 9 to decrypt the data stored in the subsequently-inserted cartridge. Conversely, if the tape medium in the subsequently-inserted cartridge is blank, or is to be overwritten with new data, the stored encryption key can be used to encrypt data that are then transferred to the tape in the subsequently-inserted cartridge in encrypted form, and written onto that tape in encrypted form.

The tape drive 4 can also be used to create the key that will be entered into and stored in the cartridge memory 2. This can ensue, for example, by Scsi/SAS commands that can be supplied to an Scsi/SAS controller 8 in the tape drive 4. A user may enter such commands manually, or may implement a special application program that will generate one or more keys, and transfer them via the Scsi/SAS bus and controller 8 to the microprocessor 7 in the tape drive 4. The key or keys are then supplied from the microprocessor 7 to the memory read/write module 6, and are transferred to, and stored in, the cartridge memory 2 in the reverse of the procedure described above.

Although modifications and changes may be suggested by those skilled in the art, it is the intention of the inventor to embody within the patent warranted hereon all changes and modifications as reasonably and properly come within the scope of his contribution to the art.

I claim as my invention:

1. An encryption key carrier consisting of:
an empty cartridge housing having a standardized tape drive form factor allowing insertion of the empty cartridge housing into a standardized magnetic tape drive; and
a memory chip permanently attached to said housing and having an encryption key stored therein, said memory chip having a chip configuration allowing readout of said encryption key when said housing is inserted in a tape drive conforming to the standardized tape drive form factor.

2. An encryption key carrier as claimed in claim 1 wherein said memory chip has a configuration allowing readout of said encryption key only when said housing is inserted in said tape drive.

3. An encryption key carrier as claimed in claim 1 wherein said empty cartridge housing has an LTO form factor as said standardized form factor.

4. An encryption key carrier as claimed in claim 1 wherein said memory chip is configured for wireless readout of said encryption key therefrom.

5. A magnetic tape medium read/write system comprising:
a tape drive having a standardized form factor;
an encryption key carrier consisting of an empty cartridge housing having a standardized tape drive form factor allowing insertion of the empty cartridge housing into a standardized magnetic tape drive, and a memory chip permanently attached to said housing and having an encryption key stored therein, said memory chip having a chip configuration allowing readout of said encryption key when said housing is inserted in a tape drive conforming to the standardized tape drive form factor; and
a magnetic tape-containing cartridge having said form factor that is subsequently insertable into said tape drive, said tape drive interacting with the subsequently inserted magnetic tape-containing cartridge to transfer data between the tape drive and the magnetic tape in the tape-containing cartridge using the encryption key.

6. A system as claimed in claim 5 wherein said memory chip has a configuration allowing readout of said encryption key only when said housing is inserted in said tape drive.

7. A system as claimed in claim 5 wherein said empty cartridge housing has an LTO form factor as said standardized form factor.

8. A system as claimed in claim 5 wherein said memory chip is configured for wireless readout of said encryption key therefrom.

9. A system as claimed in claim 5 comprising, in said tape drive, a controller allowing input of at least one encryption key thereto, said controller interacting with said memory chip while said empty cartridge is inserted in said tape drive to write said at least one key into said memory.

10. A method for physically transporting an encryption key comprising the steps of:
providing an empty cartridge housing having a standardized form factor allowing insertion of the empty cartridge housing into a standardized magnetic tape drive;
storing an encryption key in a memory chip and permanently attaching said memory chip to said housing; and
inserting said empty cartridge housing into a standardized tape drive having said form factor and reading out said encryption key from said memory chip into said standardized tape drive form factor while said housing is inserted in said standardized tape drive.

11. A method as claimed in claim 10 wherein said standardized tape drive comprises a processor having a data input, and wherein the step of storing said encryption key is said memory chip comprises supplying said encryption key to said processor via said data input, establishing communication between said processor and said memory chip while said empty cartridge is inserted in said tape drive, and transferring said encryption key from said processor to said memory chip.
